(19) United States
(12) Patent Application Publication
(10) Pub. No.: US 2023/0353210 A1
(43) Pub. Date: Nov. 2, 2023

(54) METHODS FOR CODEBOOK CONFIGURATION AND CAPABILITY FOR CSI WITH FDD RECIPROCITY

(71) Applicant: QUALCOMM Incorporated, San Diego, CA (US)

(72) Inventors: Chenxi HAO, Beijing (CN); Yu ZHANG, San Diego, CA (US); Hao XU, Beijing (CN)

(21) Appl. No.: 18/043,134

(22) PCT Filed: Oct. 23, 2020
(86) PCT No.: PCT/CN2020/123181

§ 371 Date: Feb. 27, 2023

(51) Int. Cl. H04B 7/06

(52) U.S. Cl. CPC H04B 7/0626

(57) ABSTRACT

Certain aspects of the present disclosure relate to wireless communications, and more particularly, to techniques for CSI reporting based on UE capability to support port selection codebook.

### BACKGROUND

### Field of the Disclosure

Aspects of the present disclosure relate to wireless communications, and more particularly, to techniques for channel state information (CSI) reporting.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations (BSs), which are each capable of simultaneously supporting communication for multiple communication devices, otherwise known as user equipments (UEs). In an LTE or LTE-A network, a set of one or more base stations may define an eNodeB (eNB). In other examples (e.g., in a next generation, a new radio (NR), or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more DUs, in communication with a CU, may define an access node (e.g., which may be referred to as a BS, 5G NB, next generation NodeB (gNB or gNodeB), transmission reception point (TRP), etc.). A BS or DU may communicate with a set of UEs on downlink channels (e.g., for transmissions from a BS or DU to a UE) and uplink channels (e.g., for transmissions from a UE to BS or DU).

These multiple access technologies have been adopted in various telecommunication standards to provide a common protocol that enables different wireless devices to communicate on a municipal, national, regional, and even global level. NR (e.g., new radio or 5G) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Certain aspects of the disclosure relate to a method for wireless communication by a user equipment (UE). The method generally includes transmitting, to a network entity, information regarding a set of capabilities for the UE to support a port-selection codebook, receiving a configuration for codebook based CSI reporting, based on the information, wherein the configuration comprises at least two of a number of CSI-RS ports, a number of SD-FD basis pairs, a number of FD bases identified per port, or a number of partial bands, performing CSI measurements based on the configuration, and reporting the CSI.

Certain aspects of the disclosure relate to a method for wireless communication by a network entity. The method generally includes receiving, from a user equipment (UE), information regarding a set of capabilities for the UE to support a port-selection codebook, transmitting the UE a configuration for codebook based CSI reporting, based on the information, wherein the configuration comprises at least two of a number of CSI-RS ports, a number of SD-FD basis pairs, a number of FD bases identified per port, or a number of partial bands, and receiving, from the UE, CSI measurements based on the configuration.

Aspects of the present disclosure also provide various apparatuses, means, and computer readable including instructions for performing the operations described herein.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram showing examples for implementing a communication protocol stack in the example RAN architecture, in accordance with certain aspects of the present disclosure.

FIG. 3 is a block diagram conceptually illustrating a design of an example base station (BS) and user equipment (UE), in accordance with certain aspects of the present disclosure.

FIG. 4 illustrates an example of a frame format for a telecommunication system, in accordance with certain aspects of the present disclosure.

FIG. 5 illustrates a conceptual example of precoder matrices, in accordance with certain aspects of the present disclosure.

FIG. 6 is a call flow diagram illustrating a first example of Type II CSI feedback.

FIG. 7 is a call flow diagram illustrating a second example of Type II CSI feedback.

FIGS. 8A and 8B illustrate example ports and layer to port mapping.

FIG. 9 illustrates an example of CSI calculation for port selection.

FIG. 10 illustrates example SD-FD pair to port mapping.

FIG. 11 illustrates an example of CSI calculation for port selection.

FIG. 12 illustrates an example partial band CSI.

FIG. 13 illustrates an example of CSI support for different scenarios.

FIG. 14 illustrates example operations for wireless communication by a UE, in accordance with certain aspects of the present disclosure.

FIG. 15 illustrates example operations for wireless communication by a network entity, in accordance with certain aspects of the present disclosure.

FIGS. 16-22 illustrate examples of CSI capability support reporting and configuration, in accordance with certain aspects of the present disclosure.

FIG. 23 illustrates a device with example components capable of performing various operations in accordance with certain aspects of the present disclosure.

FIG. 24 illustrates a device with example components capable of performing various operations in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure relate to wireless communications, and more particularly, to techniques for efficiently configuration and reporting of channel state information (CSI) reporting based on UE capability.

CSI enhancements with frequency division duplexing (FDD) reciprocity (in uplink and downlink) is a focus for improving system performance. In some enhanced CSI procedures, a UE may first transmit SRS and the network will determine spatial domain (SD) and frequency domain (FD) bases used for CSI-RS beamforming. The UE may then measure beamformed CSI-RS ports and reports CSI as a linear combination of the beamformed ports.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS).

New Radio (NR) is an emerging wireless communications technology under development in conjunction with the 5G Technology Forum (5GTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

New radio (NR) access (e.g., 5G technology) may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

### Example Wireless Communications System

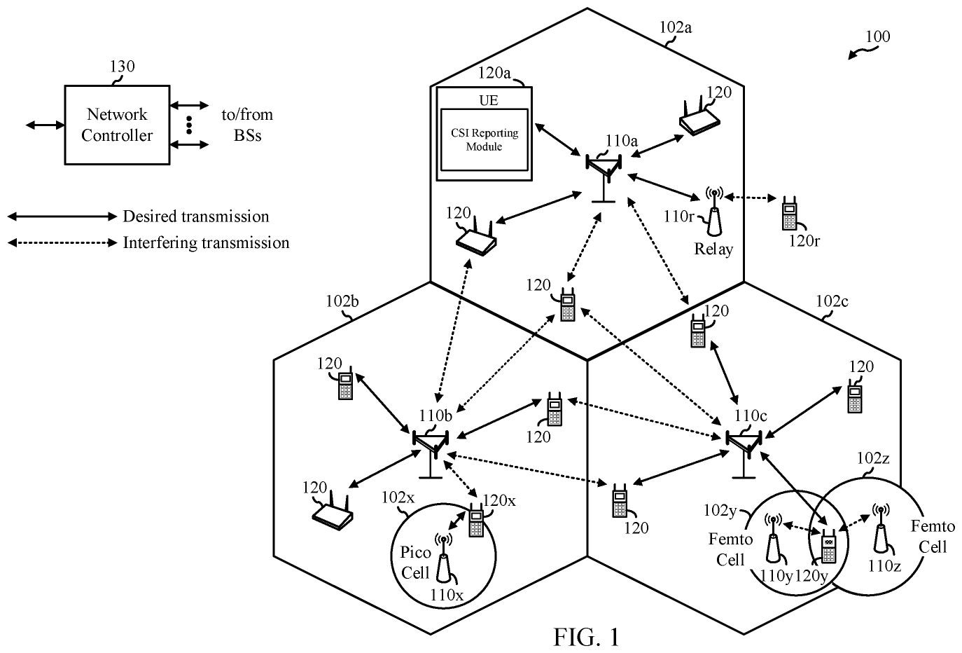

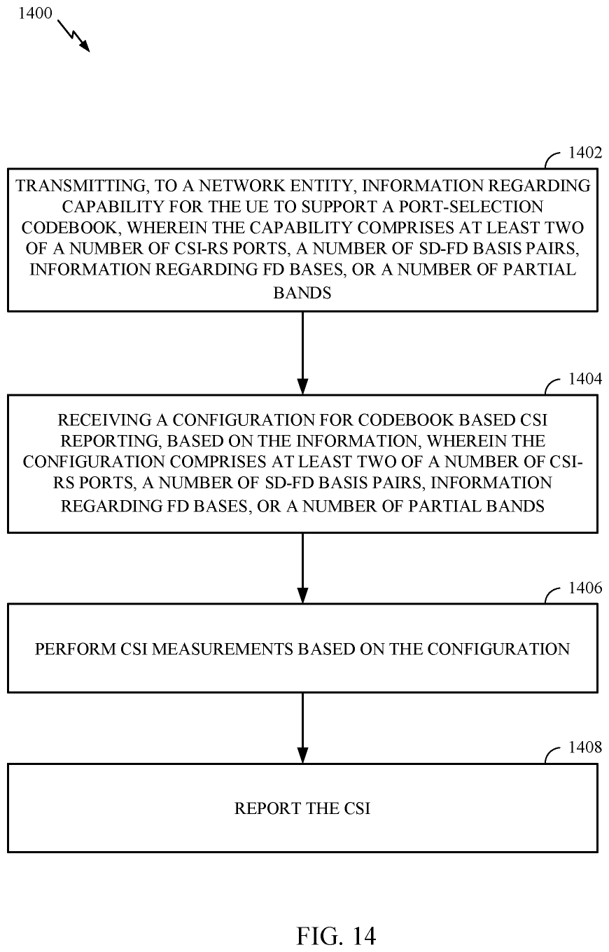

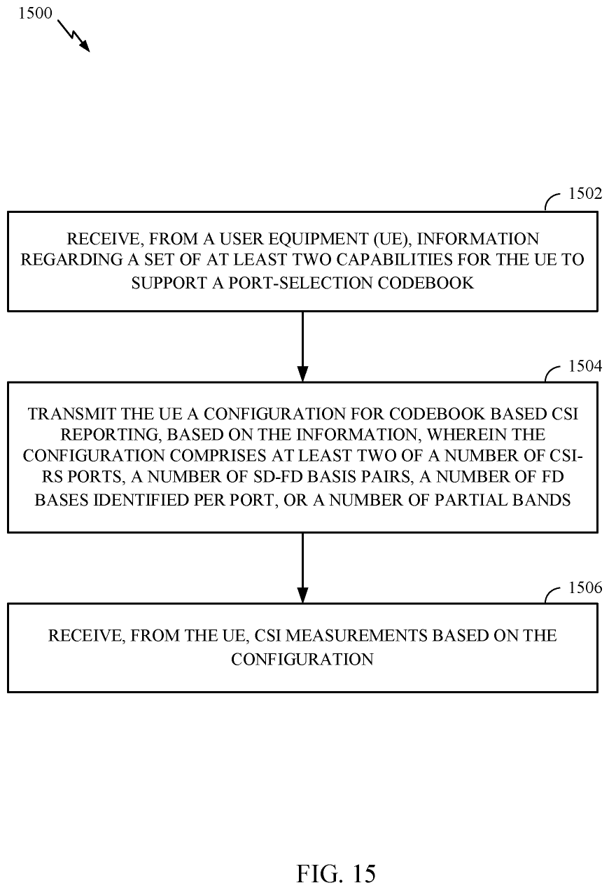

FIG. 1 illustrates an example wireless communication network 100 in which aspects of the present disclosure may be performed. For example, a UE 120 in the wireless communication network 100 may include a CSI reporting module configured to perform (or assist the UE 120 in performing) operations 1400 described below with reference to FIG. 14. Similarly, a base station 120 (e.g., a gNB) may be configured to perform operations 1500 described below with reference to FIG. 15.

As illustrated in FIG. 1, the wireless communication network 100 may include a number of base stations (BSs) 110 and other network entities. ABS may be a station that communicates with user equipment (UE). Each BS 110 may provide communication coverage for a particular geographic area. In 3GPP, the term “cell” can refer to a coverage area of a Node B (NB) and/or a NB subsystem serving this coverage area, depending on the context in which the term is used. In NR systems, the term “cell” and next generation NodeB (gNB or gNodeB), NR BS, 5G NB, access point (AP), or transmission reception point (TRP) may be interchangeable. In some examples, a cell may not necessarily be stationary, and the geographic area of the cell may move according to the location of a mobile BS. In some examples, the base stations may be interconnected to one another and/or to one or more other base stations or network nodes (not shown) in wireless communication network 100 through various types of backhaul interfaces, such as a direct physical connection, a wireless connection, a virtual network, or the like using any suitable transport network.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, NR or 5G RAT networks may be deployed.

A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. ABS may support one or multiple (e.g., three) cells.

Wireless communication network 100 may also include relay stations. A relay station is a station that receives a transmission of data and/or other information from an upstream station (e.g., a BS or a UE) and sends a transmission of the data and/or other information to a downstream station (e.g., a UE or a BS). A relay station may also be a UE that relays transmissions for other UEs. In the example shown in FIG. 1, a relay station 110r may communicate with the BS 110a and a UE 120r in order to facilitate communication between the BS 110a and the UE 120r. A relay station may also be referred to as a relay BS, a relay, etc.

Wireless communication network 100 may be a heterogeneous network that includes BSs of different types, e.g., macro BS, pico BS, femto BS, relays, etc. These different types of BSs may have different transmit power levels, different coverage areas, and different impact on interference in the wireless communication network 100. For example, macro BS may have a high transmit power level (e.g., 20 Watts) whereas pico BS, femto BS, and relays may have a lower transmit power level (e.g., 1 Watt).

Wireless communication network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time. The techniques described herein may be used for both synchronous and asynchronous operation.

A network controller 130 may couple to a set of BSs and provide coordination and control for these BSs. The network controller 130 may communicate with the BSs 110 via a backhaul. The BSs 110 may also communicate with one another (e.g., directly or indirectly) via wireless or wireline backhaul.

The UEs 120 (e.g., 120x, 120y, etc.) may be dispersed throughout the wireless communication network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into sub-bands. For example, a sub-band may cover 1.8 MHz (i.e., 6 resource blocks), and there may be 1, 2, 4, 8, or 16 sub-bands for system bandwidth of 1.25, 2.5, 5, 10 or 20 MHz, respectively.

Communication systems such as NR may utilize OFDM with a cyclic prefix (CP) on the uplink and downlink and include support for half-duplex operation using time division duplex (TDD). Beamforming may be supported and beam direction may be dynamically configured. MIMO transmissions with precoding may also be supported. MIMO configurations in the DL may support up to 8 transmit antennas with multi-layer DL transmissions up to 8 streams and up to 4 streams per UE. Multi-layer transmissions with up to 4 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In FIG. 1, a solid line with double arrows indicates desired transmissions between a UE and a serving BS, which is a BS designated to serve the UE on the downlink and/or uplink. A finely dashed line with double arrows indicates interfering transmissions between a UE and a BS.

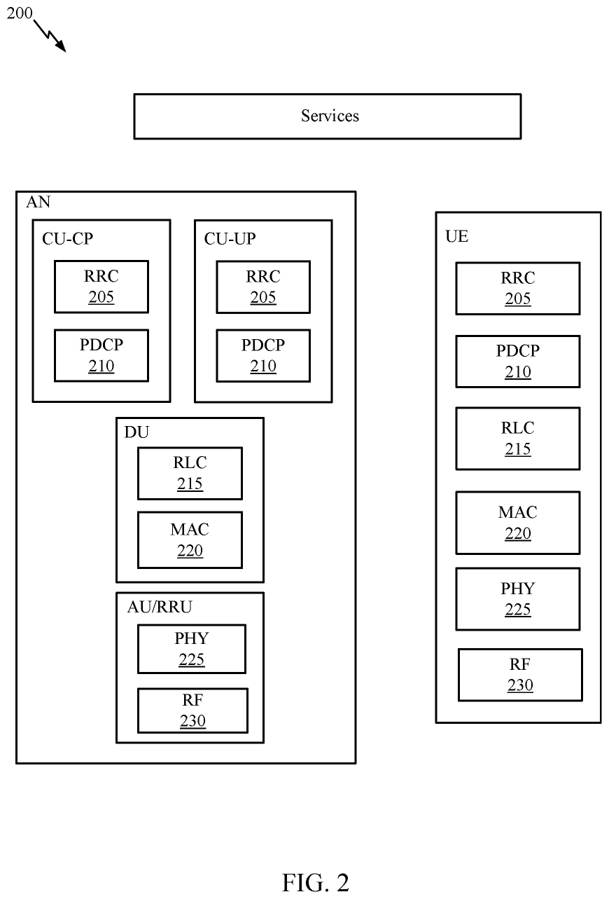

FIG. 2 illustrates a diagram showing examples for implementing a communications protocol stack in a RAN (e.g., such as the RAN 100), according to aspects of the present disclosure. The illustrated communications protocol stack 200 may be implemented by devices operating in a wireless communication system, such as a 5G NR system (e.g., the wireless communication network 100). In various examples, the layers of the protocol stack 200 may be implemented as separate modules of software, portions of a processor or ASIC, portions of non-collocated devices connected by a communications link, or various combinations thereof. Collocated and non-collocated implementations may be used, for example, in a protocol stack for a network access device or a UE. As shown in FIG. 2, the system may support various services over one or more protocols. One or more protocol layers of the protocol stack 200 may be implemented by the AN and/or the UE.

As shown in FIG. 2, the protocol stack 200 is split in the AN (e.g., BS 110 in FIG. 1). The RRC layer 205, PDCP layer 210, RLC layer 215, MAC layer 220, PHY layer 225, and RF layer 230 may be implemented by the AN. For example, the CU-CP may implement the RRC layer 205 and the PDCP layer 210. A DU may implement the RLC layer 215 and MAC layer 220. The AU/RRU may implement the PHY layer(s) 225 and the RF layer(s) 230. The PHY layers 225 may include a high PHY layer and a low PHY layer.

The UE may implement the entire protocol stack 200 (e.g., the RRC layer 205, the PDCP layer 210, the RLC layer 215, the MAC layer 220, the PHY layer(s) 225, and the RF layer(s) 230).

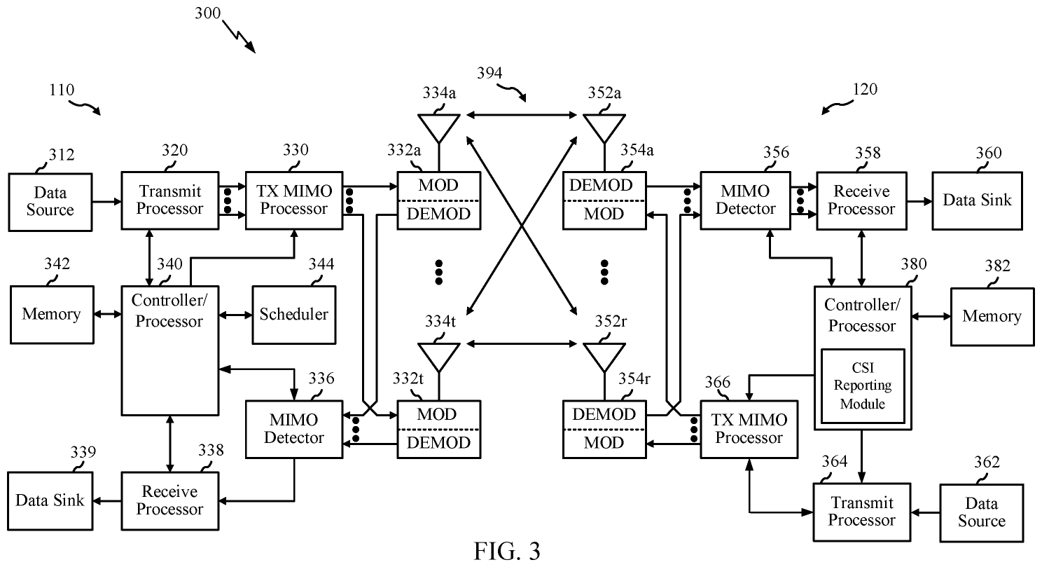

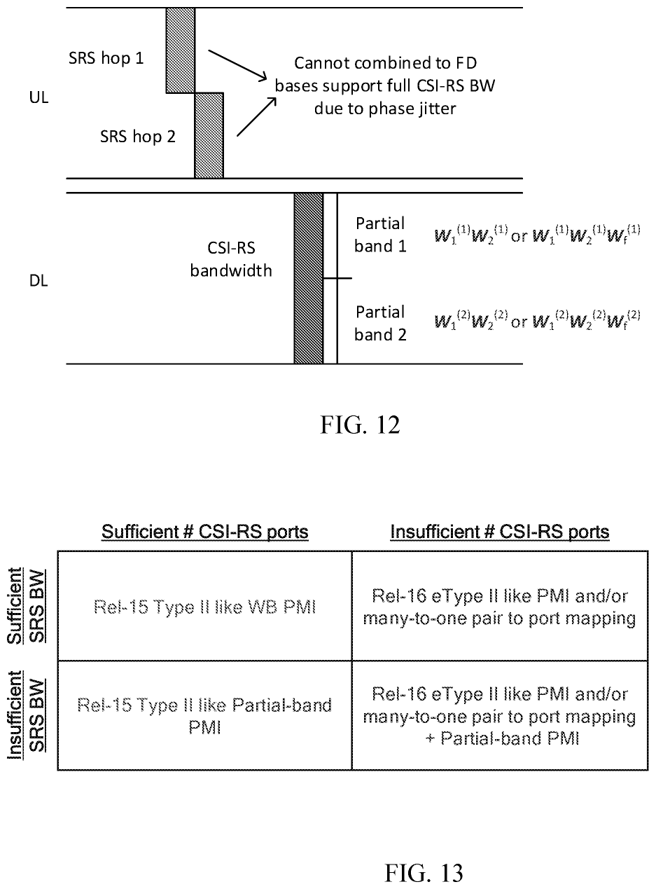

FIG. 3 illustrates example components of BS 110 and UE 120 (as depicted in FIG. 1), which may be used to implement aspects of the present disclosure. For example, antennas 352, processors 366, 358, 364, and/or controller/processor 380 of the UE 120 may be configured (or used) to perform operations 1200, 1500, and/or 1900 described below with reference to FIGS. 12, 15, and 19. Similarly, antennas 334, processors 320, 330, 338, and/or controller/processor 340 of the BS 110 may be configured (or used) to perform operations 1300, 1600, or 2000 described below with reference to FIGS. 13, 16, and 20.

At the BS 110, a transmit processor 320 may receive data from a data source 312 and control information from a controller/processor 340. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 320 may process (e.g., encode and symbol map) the data and control information to obtain data symbols and control symbols, respectively. The processor 320 may also generate reference symbols, e.g., for the primary synchronization signal (PSS), secondary synchronization signal (SSS), and cell-specific reference signal (CRS). A transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) 332a through 332t. Each modulator 332 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 332a through 332t may be transmitted via the antennas 334a through 334t, respectively.

At the UE 120, the antennas 352a through 352r may receive the downlink signals from the base station 110 and may provide received signals to the demodulators (DEMODs) in transceivers 354a through 354r, respectively. Each demodulator 354 may condition (e.g., filter, amplify, down-convert, and digitize) a respective received signal to obtain input samples. Each demodulator may further process the input samples (e.g., for OFDM, etc.) to obtain received symbols. A MIMO detector 356 may obtain received symbols from all the demodulators 354a through 354r, perform MIMO detection on the received symbols if applicable, and provide detected symbols. A receive processor 358 may process (e.g., demodulate, de-interleave, and decode) the detected symbols, provide decoded data for the UE 120 to a data sink 360, and provide decoded control information to a controller/processor 380.

In a MIMO system, a transmitter (e.g., BS 120) includes multiple transmit antennas 354a through 354r, and a receiver (e.g., UE 110) includes multiple receive antennas 352a through 352r. Thus, there are a plurality of signal paths 394 from the transmit antennas 354a through 354r to the receive antennas 352a through 352r. Each of the transmitter and the receiver may be implemented, for example, within a UE 110, a BS 120, or any other suitable wireless communication device.

The use of such multiple antenna technology enables the wireless communication system to exploit the spatial domain to support spatial multiplexing, beamforming, and transmit diversity. Spatial multiplexing may be used to transmit different streams of data, also referred to as layers, simultaneously on the same time-frequency resource. The data streams may be transmitted to a single UE to increase the data rate or to multiple UEs to increase the overall system capacity, the latter being referred to as multi-user MIMO (MU-MIMO). This is achieved by spatially precoding each data stream (i.e., multiplying the data streams with different weighting and phase shifting) and then transmitting each spatially precoded stream through multiple transmit antennas on the downlink. The spatially precoded data streams arrive at the UE(s) with different spatial signatures, which enables each of the UE(s) to recover the one or more data streams destined for that UE. On the uplink, each UE transmits a spatially precoded data stream, which enables the base station to identify the source of each spatially precoded data stream.

The number of data streams or layers corresponds to the rank of the transmission. In general, the rank of the MIMO system is limited by the number of transmit or receive antennas, whichever is lower. In addition, the channel conditions at the UE, as well as other considerations, such as the available resources at the base station, may also affect the transmission rank. For example, the rank (and therefore, the number of transmission layers) assigned to a particular UE on the downlink may be determined based on the rank indicator (RI) transmitted from the UE to the base station. The RI may be determined based on the antenna configuration (e.g., the number of transmit and receive antennas) and a measured signal-to-interference-and-noise ratio (SINR) on each of the receive antennas. The RI may indicate, for example, the number of layers that may be supported under the current channel conditions. The base station may use the RI, along with resource information (e.g., the available resources and amount of data to be scheduled for the UE), to assign a transmission rank to the UE.

On the uplink, at UE 120, a transmit processor 364 may receive and process data (e.g., for the physical uplink shared channel (PUSCH)) from a data source 362 and control information (e.g., for the physical uplink control channel (PUCCH) from the controller/processor 380. The transmit processor 364 may also generate reference symbols for a reference signal (e.g., for the sounding reference signal (SRS)). The symbols from the transmit processor 364 may be precoded by a TX MIMO processor 366 if applicable, further processed by the demodulators in transceivers 354a through 354r (e.g., for SC-FDM, etc.), and transmitted to the base station 110. At the BS 110, the uplink signals from the UE 120 may be received by the antennas 334, processed by the modulators 332, detected by a MIMO detector 336 if applicable, and further processed by a receive processor 338 to obtain decoded data and control information sent by the UE 120. The receive processor 338 may provide the decoded data to a data sink 339 and the decoded control information to the controller/processor 340.

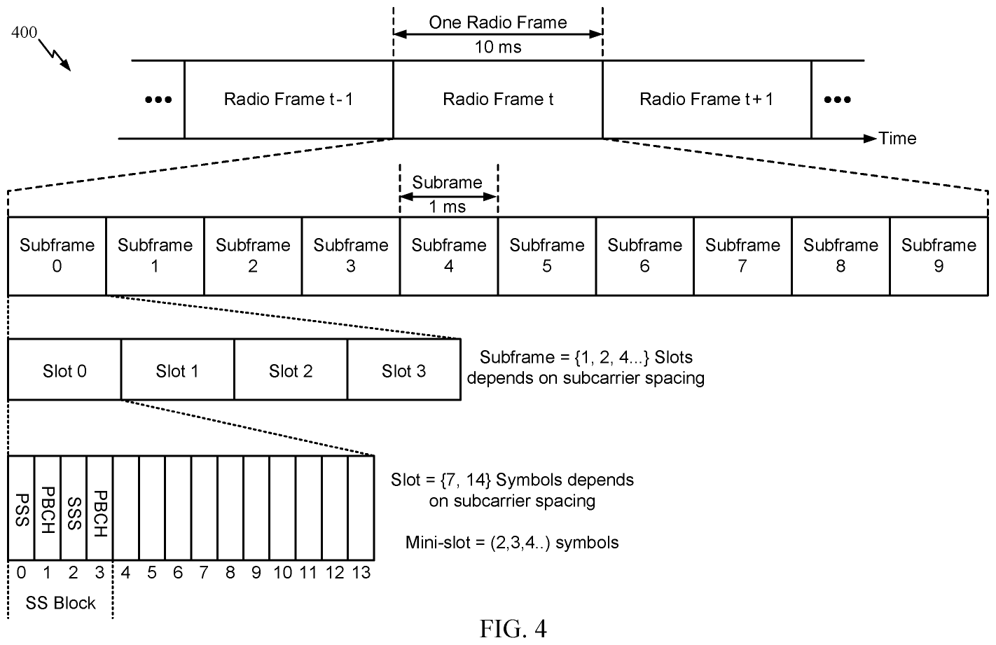

FIG. 4 is a diagram showing an example of a frame format 400 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots depending on the subcarrier spacing. Each slot may include a variable number of symbol periods (e.g., 7 or 14 symbols) depending on the subcarrier spacing. The symbol periods in each slot may be assigned indices. A mini-slot, which may be referred to as a sub-slot structure, refers to a transmit time interval having a duration less than a slot (e.g., 2, 3, or 4 symbols). Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

In NR, a synchronization signal (SS) block is transmitted. The SS block includes a PSS, a SSS, and a two symbol PBCH. The SS block can be transmitted in a fixed slot location, such as the symbols 0-3 as shown in FIG. 4. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst set periodicity, system frame number, etc. The SS blocks may be organized into SS bursts to support beam sweeping. Further system information such as, remaining minimum system information (RMSI), system information blocks (SIBs), other system information (OSI) can be transmitted on a physical downlink shared channel (PDSCH) in certain subframes. The SS block can be transmitted up to sixty-four times, for example, with up to sixty-four different beam directions for mmW. The up to sixty-four transmissions of the SS block are referred to as the SS burst set. SS blocks in an SS burst set are transmitted in the same frequency region, while SS blocks in different SS bursts sets can be transmitted at different frequency locations.

A UE may operate in various radio resource configurations, including a configuration associated with transmitting pilots using a dedicated set of resources (e.g., a radio resource control (RRC) dedicated state, etc.) or a configuration associated with transmitting pilots using a common set of resources (e.g., an RRC common state, etc.). When operating in the RRC dedicated state, the UE may select a dedicated set of resources for transmitting a pilot signal to a network. When operating in the RRC common state, the UE may select a common set of resources for transmitting a pilot signal to the network. In either case, a pilot signal transmitted by the UE may be received by one or more network access devices, such as an AN, or a DU, or portions thereof. Each receiving network access device may be configured to receive and measure pilot signals transmitted on the common set of resources, and also receive and measure pilot signals transmitted on dedicated sets of resources allocated to the UEs for which the network access device is a member of a monitoring set of network access devices for the UE. One or more of the receiving network access devices, or a CU to which receiving network access device(s) transmit the measurements of the pilot signals, may use the measurements to identify serving cells for the UEs, or to initiate a change of serving cell for one or more of the UEs.

### Example CSI Report Configuration

Channel state information (CSI) may refer to channel properties of a communication link. The CSI may represent the combined effects of, for example, scattering, fading, and power decay with distance between a transmitter and receiver. Channel estimation using pilots, such as CSI reference signals (CSI-RS), may be performed to determine these effects on the channel. CSI may be used to adapt transmissions based on the current channel conditions, which is useful for achieving reliable communication, in particular, with high data rates in multi-antenna systems. CSI is typically measured at the receiver, quantized, and fed back to the transmitter.

The time and frequency resources that can be used by the UE to report CSI are controlled by a base station (e.g., gNB). CSI may include Channel Quality Indicator (CQI), precoding matrix indicator (PMI), CSI-RS resource indicator (CRI), SS/PBCH Block Resource indicator (SSBRI), layer indicator (LI), rank indicator (RI) and/or L1-RSRP. However, as described below, additional or other information may be included in the report.

The base station may configure UEs for CSI reporting. For example, the BS configures the UE with a CSI report configuration or with multiple CSI report configurations. The CSI report configuration may be provided to the UE via higher layer signaling, such as radio resource control (RRC) signaling (e.g., CSI-ReportConfig). The CSI report configuration may be associated with CSI-RS resources for channel measurement (CM), interference measurement (IM), or both. The CSI report configuration configures CSI-RS resources for measurement (e.g., CSI-ResourceConfig). The CSI-RS resources provide the UE with the configuration of CSI-RS ports, or CSI-RS port groups, mapped to time and frequency resources (e.g., resource elements (REs)). CSI-RS resources can be zero power (ZP) or non-zero power (NZP) resources. At least one NZP CSI-RS resource may be configured for CM.

For the Type II codebook, the PMI is a linear combination of beams; it has a subset of orthogonal beams to be used for linear combination and has per layer, per polarization, amplitude and phase for each beam. For the PMI of any type, there can be wideband (WB) PMI and/or subband (SB) PMI as configured.

The CSI report configuration may configure the UE for aperiodic, periodic, or semi-persistent CSI reporting. For periodic CSI, the UE may be configured with periodic CSI-RS resources. Periodic CSI on physical uplink control channel (PUCCH) may be triggered via RRC. Semi-persistent CSI reporting on physical uplink control channel (PUCCH) may be activated via a medium access control (MAC) control element (CE). For aperiodic and semi-persistent CSI on the physical uplink shared channel (PUSCH), the BS may signal the UE a CSI report trigger indicating for the UE to send a CSI report for one or more CSI-RS resources, or configuring the CSI-RS report trigger state (e.g., CSI-AperiodicTriggerStateList and CSI-SemiPersistentOnPUSCH-TriggerStateList). The CSI report trigger for aperiodic CSI and semi-persistent CSI on PUSCH may be provided via downlink control information (DCI).

The UE may report the CSI feedback based on the CSI report configuration and the CSI report trigger. For example, the UE may measure the channel on which the triggered CSI-RS resources (associated with the CSI report configuration) is conveyed. Based on the measurements, the UE may select a preferred CSI-RS resource. The UE reports the CSI feedback for the selected CSI-RS resource. LI may be calculated conditioned on the reported CQI, PMI, RI and CRI; CQI may be calculated conditioned on the reported PMI, RI and CRI; PMI may be calculated conditioned on the reported RI and CRI; and RI may be calculated conditioned on the reported CRI.

Each CSI report configuration may be associated with a single downlink bandwidth part (BWP). The CSI report setting configuration may define a CSI reporting band as a subset of subbands of the BWP. The associated DL BWP may indicated by a higher layer parameter (e.g., bwp-Id) in the CSI report configuration for channel measurement and contains parameter(s) for one CSI reporting band, such as codebook configuration, time-domain behavior, frequency granularity for CSI, measurement restriction configurations, and the CSI-related quantities to be reported by the UE. Each CSI resource setting may be located in the DL BWP identified by the higher layer parameter, and all CSI resource settings may be linked to a CSI report setting have the same DL BWP.

In certain systems, the UE can be configured via higher layer signaling (e.g., in the CSI report configuration) with one out of two possible subband sizes (e.g., reportFreqConfiguration contained in a CSI-ReportConfig) which indicates a frequency granularity of the CSI report, where a subband may be defined as N_{PRB}^{SB} contiguous physical resource blocks (PRBs) and depends on the total number of PRBs in the bandwidth part. The UE may further receive an indication of the subbands for which the CSI feedback is requested. In some examples, a subband mask is configured for the requested subbands for CSI reporting. The UE computes precoders for each requested subband and finds the PMI that matches the computed precoder on each of the subbands.

### Compressed CSI Feedback Coefficient Reporting

As discussed above, a user equipment (UE) may be configured for channel state information (CSI) reporting, for example, by receiving a CSI configuration message from the base station. In certain systems (e.g., 3GPP Release 15 5G NR), the UE may be configured to report at least a Type II precoder across configured frequency domain (FD) units. For example, the precoder matrix Wᵣ for layer r includes the W₁ matrix, reporting a subest of selected beams using spatial compression and the W_{2,r} matrix, reporting (for cross-polarization) the linear combination coefficients for the selected beams (2L) across the configured FD units:

$${W}_{r} = {\sum }_{i = 0}^{2 L - 1} {b}_{i} \cdot {c}_{i} ,$$

$$where {c}_{i} = [ \text{?} ] ,$$

$$\text{?} \text{indicates text missing or illegible when filed}$$

where bᵢ is the selected beam, cᵢ is the set of linear combination coefficients (i.e., entries of W_{2,r} matrix), L is the number of selected spatial beams, and N₃ corresponds to the number of frequency units (e.g., subbands, resource blocks (RBs), etc.). In certain configurations, L is RRC configured. The precoder is based on a linear combination of DFT beams. The Type II codebook may improve MU-MIMO performance. In some configurations considering there are two polarizations, the W_{2,r} matrix has size 2L×N₃.

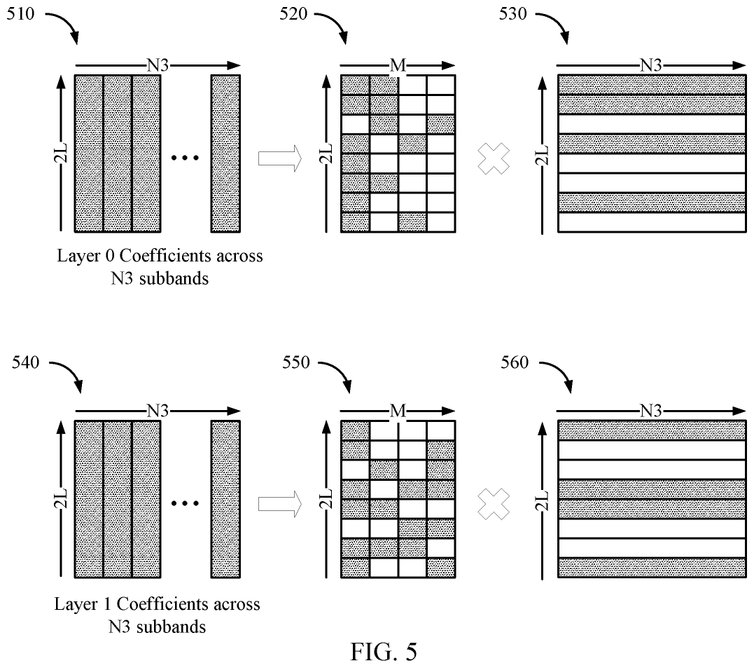

In certain systems (e.g., Rel-16 5G NR), the UE may be configured to report FD compressed precoder feedback to reduce overhead of the CSI report. As shown in FIG. 5, the precoder matrix (W_{2,i}) for layer i with i=0,1 may use an FD compression W_{f,i}^{H} matrix to compress the precoder matrix into \tilde{W}_{2,i} matrix size to 2L×M (where M is network configured and communicated in the CSI configuration message via RRC or DCI, and M<N₃) given as:

Wᵢ=W₁\tilde{W}_{2,i}W_{f,i}^{H}

Where the precoder matrix Wᵢ (not shown) has P=2N₁N₂ rows (spatial domain, number of ports) and N₃ columns (frequency-domain compression unit containing RBs or reporting sub-bands), and where M bases are selected for each of layer 0 and layer 1 independently. The \tilde{W}_{2,0} matrix 520 consists of the linear combination coefficients (amplitude and co-phasing), where each element represents the coefficient of a tap for a beam. The \tilde{W}_{2,0} matrix 520 as shown is defined by size 2L×M, where one row corresponds to one spatial beam in W₁ (not shown) of size P×2L (where L is network configured via RRC), and one entry therein represents the coefficient of one tap for this spatial beam. The UE may be configured to report (e.g., CSI report) a subset K₀<2LM of the linear combination coefficients of the \tilde{W}_{2,0} matrix 520. For example, the UE may report K_{NZ,i}<K₀ coefficients (where K_{NZ,i} corresponds to a maximum number of non-zero coefficients for layer-i with i=0 or 1, and K₀ is network configured via RRC) illustrated as shaded squares (unreported coefficients are set to zero). In some configurations, an entry in the \tilde{W}_{2,0} matrix 520 corresponds to a row of W_{f,0}^{H} matrix 530. In the example shown, both the \tilde{W}_{2,0} matrix 520 at layer 0 and the \tilde{W}_{2,0} matrix 550 at layer 1 are 2L×M.

The W_{f,0}^{H} matrix 530 is composed of the basis vectors (each row is a basis vector) used to perform compression in frequency domain. In the example shown, both the W_{f,0}^{H} matrix 530 at layer 0 and the W_{f,1}^{H} matrix 560 at layer 1 include M=4 FD basis (illustrated as shaded rows) from N₃ candidate DFT basis. In some configurations, the UE may report a subset of selected basis of the W_{f,i}^{H} matrix via CSI report. The M bases specifically selected at layer 0 and layer 1. That is, the M bases selected at layer 0 can be same/partially-overlapped/non-overlapped with the M bases selected at layer 1.

### Example Type II Port-Selection CSI with Frequency Selective Precoded CSI-RS (a.k.a., FDD CSI)

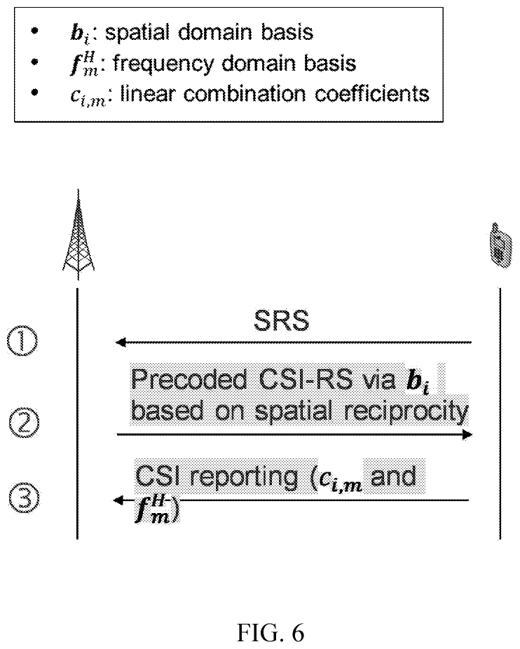

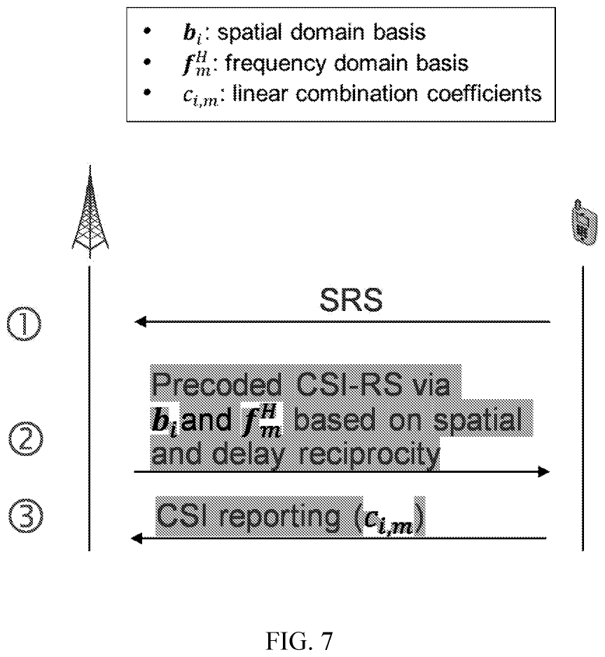

Some deployments (e.g., NR Release 16 and 17 systems) support enhancements to CSI based feedback that are designed to exploit directional (angle) and delay reciprocity (meaning the same or similar conditions may be assumed to be observed on the uplink and downlink). FIGS. 6 and 7 illustrate examples of such CSI based feedback where a gNB obtains the following terms based on a combination of SRS measurements taken at the gNB and feedback from the UE:
bᵢ: spatial domain basis;
fₘ^{H}: frequency domain basis; and
c_{i,m}: linear combination coefficients.

FIG. 6 is a call flow diagram illustrating an example of Type II port-selection CSI feedback (according to Release 16). The UE transmits SRS that the gNB measures to determine a spatial domain basis (bᵢ). Assuming spatial reciprocity, the gNB precodes CSI-RS via the spatial domain basis (bᵢ), wherein each CSI-RS port may be precoded via a particular spatial domain basis. Based on measurements of the precoded CSI-RS, the UE determines preferred CSI-RS ports and reports them and also reports other terms (c_{i,m} and fₘ^{H}) used to combine the preferred CSI-RS ports.

The term CSI-RS port refers to an antenna port used for CSI-RS transmission. An antenna port is a logical concept related to physical layer (L1), rather than an actual physical RF antenna. According to the 3GPP specification definition, an antenna port is defined such that the channel over which a symbol on the antenna port is conveyed can be inferred from the channel over which another symbol on the same antenna port is conveyed. In other words, each individual downlink transmission is carried out from a specific antenna port, the identity of which is known to the UE and the UE can assume that two transmitted signals have experienced the same radio channel if and only if they are transmitted from the same antenna port. The mapping of antenna ports to physical antennas is generally controlled by beam forming as a certain beam needs to transmits the signal on certain antenna ports to form a desired beam. As such, it is possible that two antenna ports may be mapped to one physical antenna port or that a single antenna port may be mapped to multiple physical antenna ports.

FIG. 7 is a call flow diagram illustrating another example of Type II CSI feedback (according to Release 17). In this case, the gNB determines both (bᵢ) and fₘ^{H} based on SRS measurements. Assuming both spatial and delay reciprocity, the gNB precodes CSI-RS via the spatial domain basis (bᵢ) and the frequency domain basis fₘ^{H}, wherein each CSI-RS port maybe precoded via a particular pair of a spatial domain basis and a frequency domain basis. Based on measurements of the precoded CSI-RS, the UE determines preferred CSI-RS ports and reports them and also reports c_{i,m} used to combine the preferred CSI-RS ports.

In scenarios where there is an ideal spatial and delay reciprocity in the uplink and downlink frequency band, such as time division duplexing (TDD) scenarios, the CSI reporting of FIG. 7 may have certain benefits. Examples of such benefits include lower reporting overhead, lower UE complexity, and higher performance due to finer resolution of frequency domain basis and higher performance due to better spatial and frequency bases (gNB can use bases other than DFT bases, e.g., SVD bases, to gain more performance benefit).

For the frequency selective precoding shown in FIG. 7, on an FD unit (RB or subband), the precoder of a CSI-RS port is formed by a pair of an SD basis (or spatial domain transmission filter) bᵢ and an FD basis (frequency domain transmission filter/weight) fₘ. When generating a wideband (WB) CSI report, for a given port p, the UE observes:

Ĥₚ[n]=Hbᵢ₍ₚ₎fₘ₍ₚ₎^{H}[n] on FD unit n;

based on which the UE calculates CSI. In this equation, H is the wireless channel between UE and gNB without precoding, where i(p) and m(p) denote the indices of the spatial and frequency bases applied on port p, respectively.

For each layer, the UE selects a subset of total ports, and reports a single coefficient per port across the frequency band. The PMI for a certain layer on any of the N₃ FD units is given as:

W=Σₖ₌₀^{K}^{₀}⁻¹vᵢ_{ₖ}·cₖ;

where vᵢ_{ₖ} is of size P×1 with only one “1” in row iₖ, P is the total number of CSI-RS ports. The UE reports

$$[ \begin{matrix}{y}^{( 3000 )} \\ ⋮ \\ {y}^{( 3000 + P - 1 )}\end{matrix} ] = W [ \begin{matrix}{x}^{( 0 )} \\ ⋮ \\ {x}^{( v - 1 )}\end{matrix} ] ;$$

and c₀, . . . c_{K}_{₀}₋₁ or a subset of c₀, . . . c_{K}_{₀}₋₁ wherein the unreported coefficients are set to 0, K₀ is the maximum number of ports allowed to be selected for linear combination.

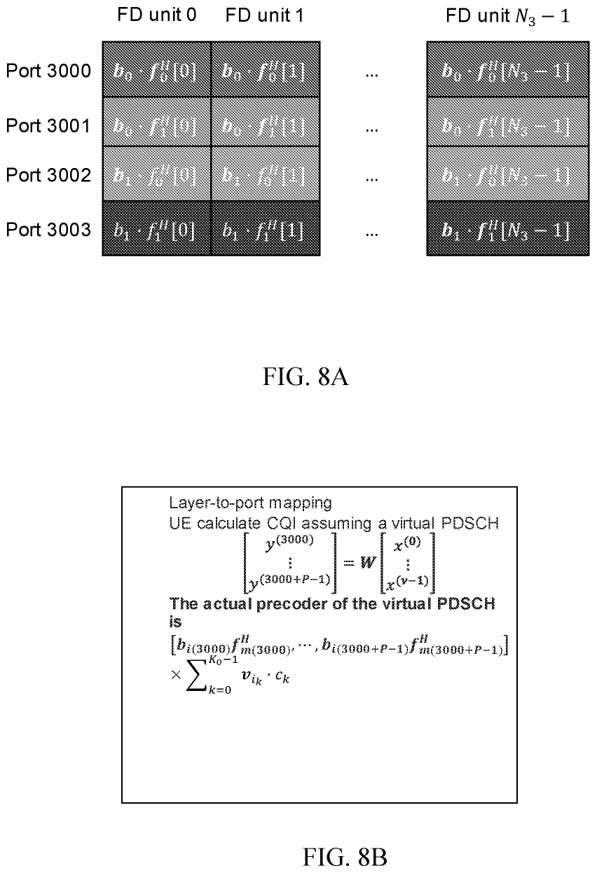

As illustrated in FIG. 8A, in current standards, the CSI-RS port index in each resource starts from 3000. As shown in FIG. 8B, the UE calculates CQI assuming a virtual PDSCH:

$$[ \begin{matrix}\begin{matrix}{y}^{( 3000 )} \\ ⋮\end{matrix} \\ {y}^{( 3000 + P - 1 )}\end{matrix} ] = W [ \begin{matrix}{x}^{( 0 )} \\ ⋮ \\ {x}^{( v - 1 )}\end{matrix} ] ;$$

and the actual precoder of the virtual PDSCH is given as:

[bᵢ₍₃₀₀₀₎fₘ₍₃₀₀₀₎^{H}, . . . ,b_{i(3000+P-1)}f_{m(3000+P-1)}^{H}]×Σₖ₌₀^{K}^{₀}⁻¹vᵢ_{ₖ}·cₖ

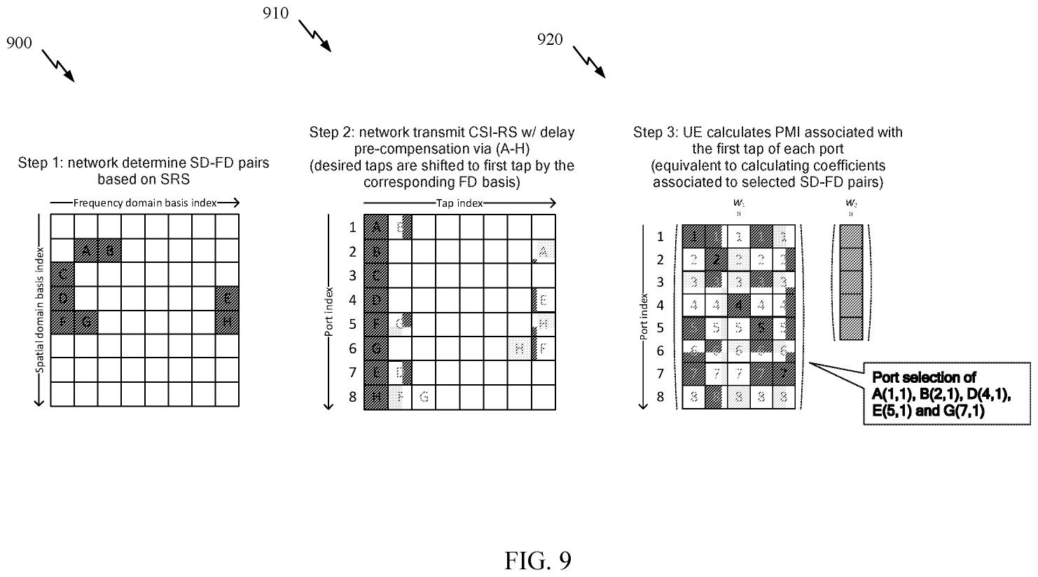

FIG. 9 illustrates an example of CSI configuration, measurement, and reporting for port selection. As shown at 900, the network may determine SD-FD basis pairs (which may be referred to as SD-FD pairs), based on SRS. In the example, 8 SD-FD pairs are determined. As shown at 910, the network may transmit 8 CSI-RS ports with delay pre-compensation via SD-FD pairs A-H. In the illustrated example, considering DFT bases are used for FD bases, the effect of delay pre-compensation is that the desired taps (associated with A-H) are shifted to a first tap by the corresponding FD basis. As shown at 920, the UE calculates PMI associated with the first tap of each port (e.g., which may be equivalent to calculating coefficients associated to selected SD-FD pairs). The illustrated example shows port selection of A(1,1), B(2,1), D(4,1), E(5,1) and G(7,1).

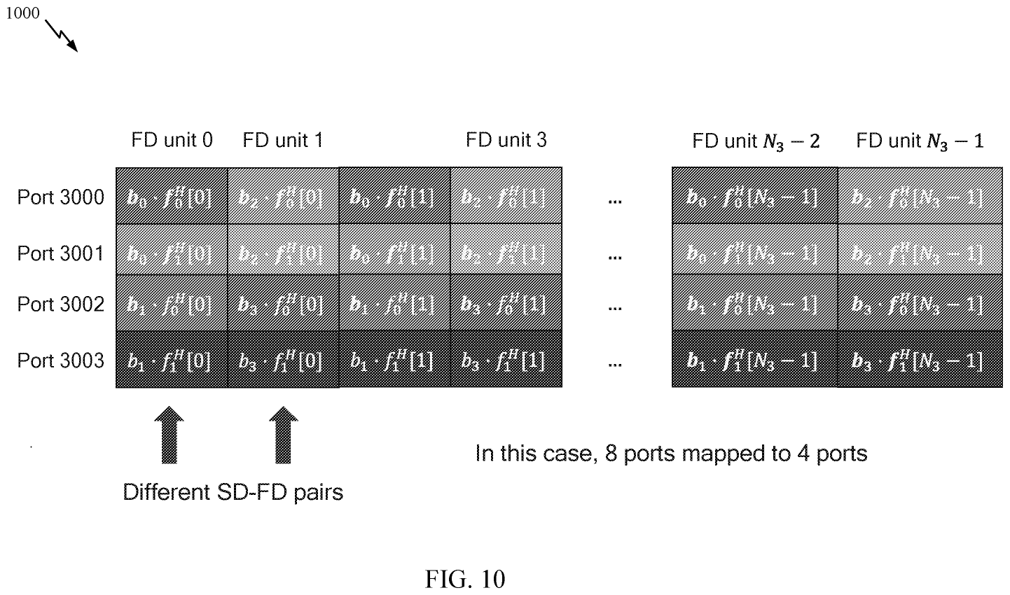

FIG. 10 illustrates an example of an interleaved SD-FD pair to port mapping. In the example illustrated in FIG. 10, 8 SD-FD pairs are mapped to 4 ports. Rel-15 Type II like codebook structure (W1*W2 or Σᵢ₌₀^{X-1}v_{i,l}·c_{i,l}) can be as basic, for example, as one-to-one mapping between a CSI-RS port and a SD-FD pair, a one-to-many mapping between a CSI-RS port (because performance relies on larger number of SD-FD pairs), 2*P pairs mapped to P ports (as shown in FIG. 10), SD-FD pair 1 to P mapped on even RBs; SD pair P+1 to 2P mapped on odd RBs, or N*P pairs mapped to P ports, SD-FD pair n*P to (n+1)*P−1 mapped on RBs n, n+N, n+2N, etc, where n=0, 1, etc. In this manner, port-selection is done via pair-selection.

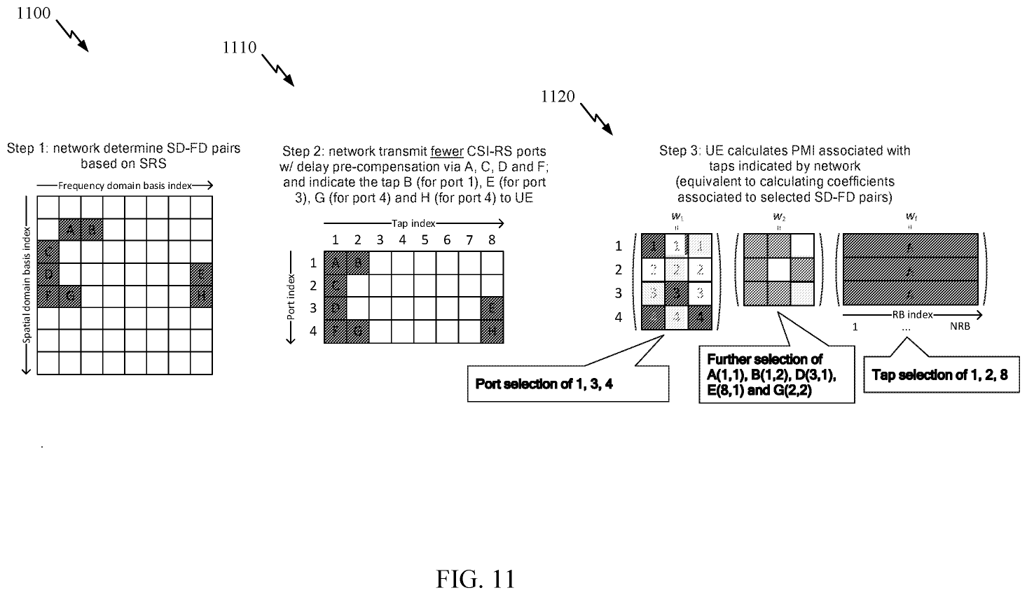

As shown in FIG. 11, a Rel-16 eType II like codebook structure (W1*W2*Wf or Σᵢ₌₀^{X-1}Σₘ₌₀^{M-1}v_{i,l}·f_{i,m,l}^{H}·c_{i,l}) may be considered an advanced feature (e.g., optional). In this case, the network may transmit fewer ports using a subset of SD-FD pairs and configure the remaining FD bases to UE or let UE report the remaining FD bases. A benefit to this approach may be CSI-RS overhead saving, as well as better throughput performance (e.g., under the same CSI-RS overhead as the basic approach in FIG. 9 as more coefficients associated to more FD bases can be reported).

As illustrated at 1100, the network may determine SD-FD pairs based on SRS. At 1110, the network transmits fewer CSI-RS ports with delay pre-compensation via A, C, D and F and indicates the tap B (for port 1), E (for port 3), G (for port 4) and H (for port 4) to UE. At 1120, the UE calculates PMI associated with taps indicated by network (e.g., which may be considered equivalent to calculating coefficients associated to selected SD-FD pairs). In the example shown in FIGS. 11, A, B, D, E and G are selected by the UE.

In some cases, SRS transmission bandwidth (including subband sounding) can be smaller than CSI-RS bandwidth. In such cases, the FD bases determined via SRS measurement may not support full downlink bandwidth. As illustrated in FIG. 12, in this case, one CSI request may trigger multiple partial band PMI reporting as advanced feature (e.g., an optional feature). In this case, a UE may report a first set of CSI for partial band 1 and reporting a second set of CSI for partial band 2.

### Example Methods for Codebook Configuration and Capability for CSI with FDD Reciprocity

Aspects of the present disclosure relate to wireless communications, and more particularly, to techniques for efficient configuration and reporting of channel state information (CSI), based on UE capability.

There are various challenges to support the various optional features described above, such as many-to-one pair-to-port mapping, Rel-16 eType II like structure (identifying >1 FD bases from each port/pair), and partial band PMIs.

There are challenges for codebook configurations to support scalable codebook configuration, for example, to address the various cases where there may be sufficient or insufficient SRS BW and/or CSI-RS ports, as shown in FIG. 13. When there are sufficient number of ports and sufficient SRS BW, the network may configure the UE to report CSI with Rel-15 Type II like structure, one-to-one mapping between port and pair and a single coefficient per port across CSI reporting band (one partial band or wideband). When there are insufficient number of ports and sufficient SRS BW, the network may configure the UE to report CSI with Rel-16 eType II like structure, one-to-one mapping between port and pair and a single coefficient per port across CSI reporting band (one partial band or wideband), or configure the UE to report CSI with Rel-15 Type II like structure, one-to-many mapping between port and pair and a single coefficient per port across CSI reporting band (one partial band or wideband). When there are sufficient number of ports but insufficient SRS BW, the network may configure the UE to report CSI with Rel-15 eType II like structure, one-to-one mapping between port and pair and multiple partial band CSI (i.e., multiple partial bands and single coefficient per port for each partial band). When there are insufficient number of CSI-RS ports and insufficient SRS BW, the network may the network may configure the UE to report CSI with Rel-16 eType II like structure, one-to-one mapping between port and pair and multiple partial band CSI (i.e., multiple partial bands and single coefficient per port for each partial band), or configure the UE to report CSI with Rel-15 Type II like structure, one-to-many mapping between port and pair and multiple partial band CSI (i.e., multiple partial bands and single coefficient per port for each partial band). For example, the reporting overhead increases with the optional features, not likely support them jointly without restriction. A many-to-one pair to port mapping may introduce more pairs, and more pairs would lead to more coefficient reporting. A Rel-16 eType II like structure (identifying >1 FD bases from each port/pair) may help introduce more (effective) pairs and more pairs would lead to more coefficients reporting. Ideally, partial band PMIs scale the number of PMIs.

FIG. 14 illustrates example operations 1400 for wireless communication by a UE. For example, operations 1400 may be performed by a UE 120 (of FIG. 1 or FIG. 3) for CSI reporting, in accordance with certain aspects of the present disclosure.

Operations 1400 begin, at 1402, by transmitting, to a network entity, information regarding a set of at least two capabilities for the UE to support a port-selection codebook. The set of capabilities may include at least any two of a number of CSI-RS ports P, information regarding a number SD-FD pairs P′, information regarding FD bases on each port or SD-FD pair (e.g., a number of FD bases M identified on each port or SD-FD pair), and information regarding partial bands B. The UE may support a same number of port and pair (1-to-1 mapping) as a basic capability, may support M=1 FD bases to be identified on each port or SD-FD pair as basic, or may support single partial band (i.e., WB) as basic.

At 1404, the UE receives a configuration for codebook based CSI reporting, based on the information, wherein the configuration comprises at least two of a number of CSI-RS ports, a number of SD-FD basis pairs, information regarding FD bases identified per port (e.g., a number of FD bases identified per port), or a number of partial bands. For example, the UE may receive a codebook configuration comprising at least any two of #CSI-RS ports P, information of SD-FD pairs P′, #FD bases M identified on each port on each port or SD-FD pair, and information of partial bands B, based on the reported capability.

At 1406, the UE performs CSI measurements based on the configuration. At 1408, the UE reports the CSI. The CSI may include a set of linear combination coefficients for each layer and each partial band and each coefficient is associated to combination of a particular CSI-RS port or SD-FD pair and a particular FD basis.

FIG. 15 illustrates example operations 1500 that may be considered complementary to operations 1400 of FIG. 14. For example, operations 1500 may be performed by a network entity (e.g., a base station, such as an eNB or gNB), to configure and receive CSI reports from a UE (performing operations 1400 of FIG. 14).

Operations 1500 begin, at 1502, by receiving, from a user equipment (UE), information regarding a set of at least two capabilities for the UE to support a port-selection codebook. At 1504, the network entity transmits the UE a configuration for codebook based CSI reporting, based on the information, wherein the configuration comprises at least two of a number of CSI-RS ports, a number of SD-FD basis pairs, information regarding FD bases identified per port (e.g., a number of FD bases identified per port), or a number of partial bands. At 1506, the network entity receives, from the UE, CSI measurements based on the configuration.

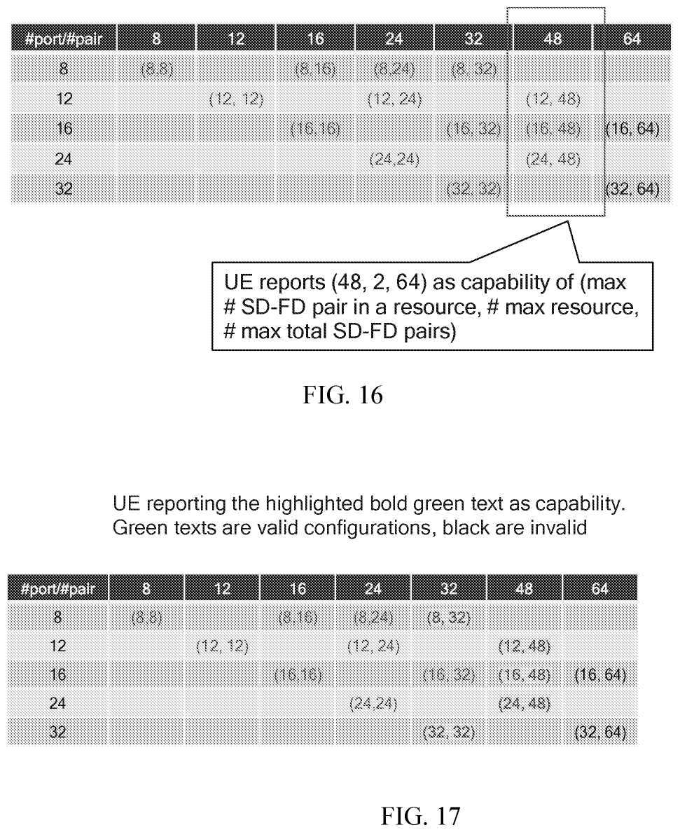

Operations of FIGS. 14 and 15 may be understood with reference to the various tables shown in FIGS. 16-22, which illustrate how a UE may indicate its capabilities to support a port selection codebook and how a network entity may configure the UE, based on the indicated capabilities.

As illustrated in FIG. 16, a UE may report capability via information of SD-FD pairs comprises reporting SD-FD pairs P′ per resource and jointly report with number of resources and total number of SD-FD pairs across all resources reporting {P′, K, Ptot′} as a capability. In any slot, the active SD-FD pairs per resource should be subject to P the number of resources containing active SD-FD pairs should be subject to K, and the total number of active SD-FD pairs across all resources should be subject to Ptot′. The UE may report a list of P′ or a list of {P′,K,Ptot′} for each codebook type, each concurrent codebook combinations (i.e., two or three codebooks that have active CSI-RS resources and ports in the same slot) on per-band basis and per-band-combination basis.

In the example illustrated in FIG. 16, each column indicates a certain number of pairs, and each row indicates a certain number of ports, the entries in the table are the candidate pairs of {#port, #pair} in a resource. If the UE reports (48, 2, 64) as capability of (max #SD-FD pair in a resource, #max resource, #max total SD-FD pairs). Thus, any of the entries in the table to the left of these reported values (with less than the reported maximum values of SD-FD pair in a resource) is a valid combination that may be configured by the network.

Active SD-FD pairs may be defined similarly to active CSI-RS ports. For aperiodic CSI-RS or an SD-FD pair, the active time may start from the end of the PDCCH containing the request and ending at the end of the PUSCH containing the report associated with this aperiodic CSI-RS. For semi-persistent CSI-RS or SD-FD pair, the active time may start from the end of when the activation command is applied, and ending at the end of when the deactivation command is applied. For periodic CSI-RS or SD-FD pair, the active time may start when the periodic CSI-RS is configured by higher layer signaling, and ending when the periodic CSI-RS configuration is released.

As illustrated in FIG. 17, a UE may report capability via information of SD-FD pairs that comprises reporting a max total number of SD-FD pairs Pmax′ mapped to P CSI-RS ports. In the example, the UE reports the highlighted values in the table as capability, while values to the left of those are valid configuration, and values to the right are invalid.

The capability may be reported as {P, Pmax′ }, as shown, or {P, K, Ptot, Pmax′} can be jointly reported, where P, K, Ptot corresponds to the tuple reported in the CSI-RS capability (max #ports in a resource, #max resource, #max total ports). In response, the UE may receive configuration of information of SD-FD pairs that comprises a total number of SD-FD pairs P′ mapped to p CSI-RS ports, p<=P′ or (p<=P and p<=P′<=Pmax′ if there is capability reporting of Pmax). {P, P′} may be jointly configured. The ports within the resource and the resource are counted P′/P times in active resource and port counting.

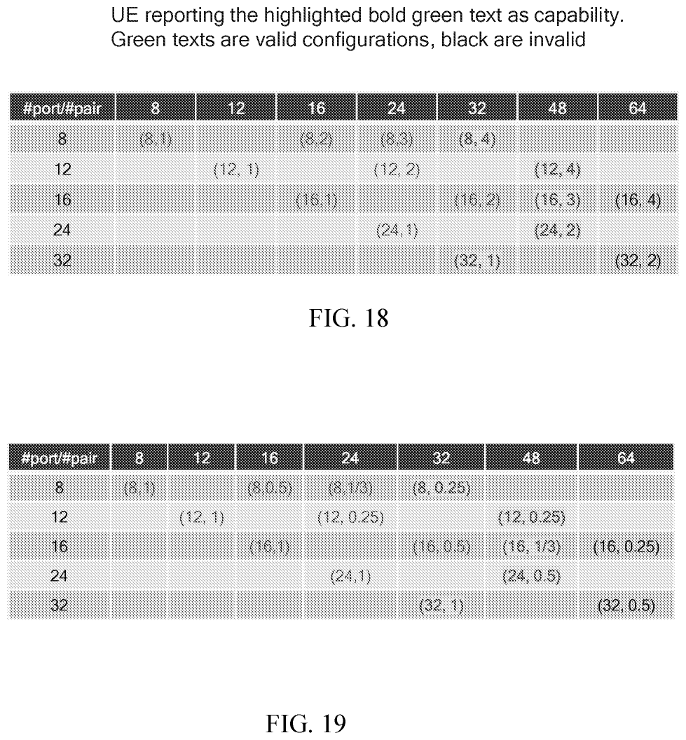

As illustrated in FIG. 18, a UE may report capability via information of SD-FD pairs that comprises reporting a max #SD-FD pairs Nmax mapped to each of the P ports; {P, Nmax} or {P, K, Ptot, Nmax} can be jointly reported, P, K, Ptot corresponds to the tuple reported in the CSI-RS capability. In the example, the UE reports the highlighted values in the table as capability, while values to the left of those are valid configuration, and values to the right are invalid.

The UE may receive configuration of information of SD-FD pairs that comprises a #SD-FD pairs N mapped to each of the P ports, the total number of SD-FD bases are derived as P*N, 1<=N<=Nmax. {P, N} may be jointly configured. The ports within the resource and the resource are counted N times in active resource and port counting.

As illustrated in FIG. 19, a UE may report capability via information of SD-FD pairs that comprises reporting a lowest density of SD-FD pairs dmin′. {P, dmin′} or {P, K, Ptot, dmin′} can be jointly reported, where P, K, Ptot corresponds to the tuple reported in the CSI-RS capability. In the example, the UE reports the highlighted values in the table as capability, while values to the left of those are valid configuration, and values to the right are invalid.

The UE may receive configuration of information of SD-FD pairs that comprises a SD-FD pair density d′, the total number of SD-FD bases are derived based on P*d/d′ where d′<=d and d is the CSI-RS density. {P, d′} may be jointly configured. The ports within the resource and the resource are counted d/d′ times in active resource and port counting.

For all cases described in FIGS. 16-19, UE may receive joint configuration of number of CSI-RS ports and information regarding SD-FD pairs (e.g., number of total pairs, number of pairs per port, or density of each pair) from the valid combinations of number of CSI-RS ports and information regarding SD-FD pairs. In some cases, UE may receive joint configuration of number of CSI-RS ports and/or information regarding SD-FD pairs and number of non-zero coefficients (e.g., determine a pre-defined list of combinations of {information regarding SD-FD pairs (e.g., number of total pairs, number of pairs per port, or density of each pair), ratio for max number of non-zero coefficients beta}, receive a combination from the list, or determine a pre-defined list of combinations of {number of CSI-RS ports, information regarding SD-FD pairs (e.g., number of total pairs, number of pairs per port, or density of each pair), ratio for max number of non-zero coefficients beta}, receive a combination from the list). In some cases, the max number of non-zero coefficients can be derived from the ratio beta, number of SD-FD pairs P′, e.g., K0=P′*beta. In some cases, K0 is the max number of non-zero coefficients per layer and 2K0 is the max number of total non-zero coefficients across all layers.

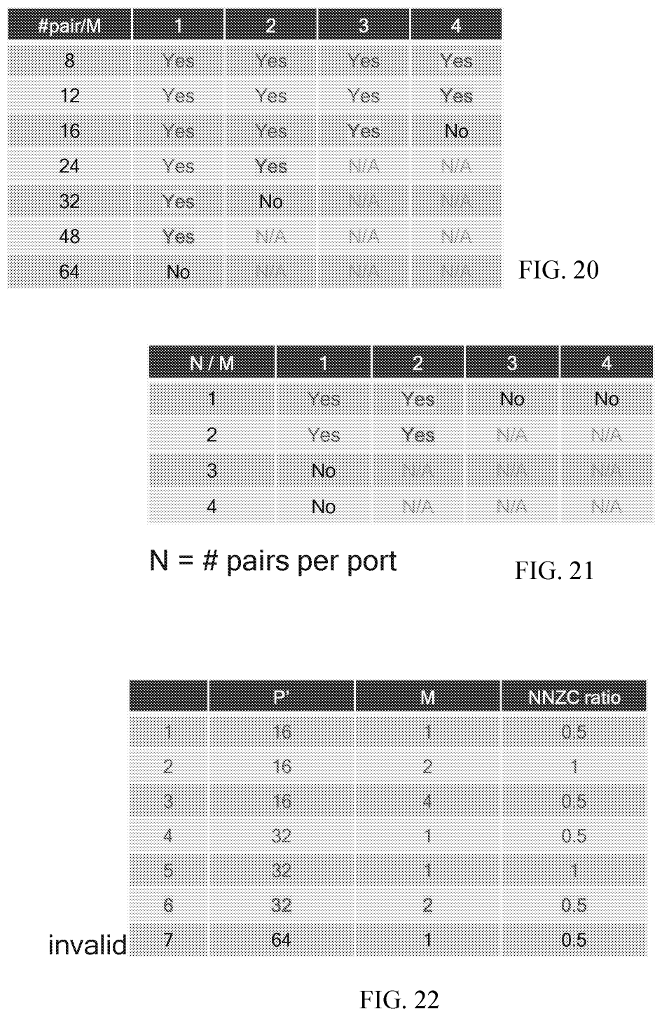

As illustrated in FIGS. 20-22, in some cases, a UE may report an explicit capability of number of FD bases per CSI-RS port or SD-FD pair, or reporting a capability of whether supporting >1 FD bases per CSI-RS port or SD-FD pair. In some cases, the UE may jointly report a number of CSI-RS ports P plus number of FD bases per port M, or information of SD-FD pair plus number of FD bases per pair as shown in FIG. 20.

In FIG. 20, each column corresponds to a certain number of FD bases per pair, each row corresponds a certain number of pair. The entries other than “N/A” indicates the candidate combinations of number of pair and number of FD bases per pair. The UE may report supporting max M=4 FD bases per pair if there are 8 or 12 pairs, report supporting max M=3 FD bases per pair if there are 16 pairs, report supporting max M=2 FD bases per pair if there are 24 pairs, report supporting max M=1 FD bases per pair if there are 32 pairs and report not supporting 64 pairs with any number of FD bases. Then, the combinations with number of FD bases less than the reported max value are valid (labeled as “YES”), otherwise they are invalid (labeled as “No”).

In some examples of FIG. 21, each column corresponds to a certain number of FD bases per pair, each row corresponds a certain number of pair per port. The entries other than “N/A” indicates the candidate combinations of number of pair per port and number of FD bases per pair. The UE may report supporting max M=2 FD bases per pair if there are 1 or 2 pairs mapped to a port and report not supporting 3 or 4 pairs mapped to a port with any number of FD bases. Then, the combinations with number of FD bases less than the reported max value are valid (labeled as “YES”), otherwise they are invalid (labeled as “No”). In some cases, a UE may jointly report CSI-RS ports P plus information of SD-FD pair plus number of FD bases per port M.

In some cases, the UE may jointly report CSI-RS ports P/SD-FD pair P′ plus M plus max number of non-zero coefficients, as shown in FIG. 22. In FIG. 22, each row corresponds to a combination of number of SD-FD pair P′, number of FD bases M per port and max ratio for number of non-zero coefficients. The UE may report supported combination indices or report a max supported index and all the combination indices smaller than the reported index are valid.

In some cases, the indication and/or configuration of #FD bases may be via an indication/or configuration of a factor alpha, and the #FD bases is derived via a pre-defined function of alpha. The function may also have a parameter of at least one of: number of total PMI subbands, number of PMIs per CQI subband, number of CSI-RS ports or SD-FD pairs. For example, the function could be:

#FD_bases=ceil(#PMIsubbands/#PMIs_per_subband*alpha); or

#FD_bases=ceil(#PMIsubbands/#PMIs_per_subband*alpha*P0/#CSIRS_ports), or

#FD_bases=ceil(#PMIsubbands/#PMIs_per_subband*alpha*P0/#SDFD_pairs), or

#FD_bases=ceil(#PMIsubbands/#PMIs_per_subband*alpha*#CSIRS_ports/#SDFD_pairs)

where P0 is a fixed value (e.g., P0=8).

A UE may receive configuration of number of FD bases comprises a configuration of a common value to each port or a specific value to a specific port. In some cases, the UE may receive joint configuration of CSI-RS ports P plus number of FD bases per port M (e.g., determine a pre-defined list of combinations of {number of CSI-RS ports, number of FD bases per port M}, receive a combination from the list), or information of SD-FD pair plus number of FD bases per pair (e.g., determine a pre-defined list of combinations of {information of SD-FD pair (number of total pairs, or number of pairs per port, or density of each pair), number of FD bases per port M}, receive a combination from the list), or CSI-RS ports P plus information of SD-FD pair plus number of FD bases per port M (e.g., determine a pre-defined list of combinations of {number of CSI-RS ports P, information of SD-FD pair (number of total pairs, or number of pairs per port, or density of each pair), number of FD bases per port M}, receive a combination from the list). In some cases, the UE may receive joint configuration of CSI-RS ports P/SD-FD pair P′ plus M plus max number of non-zero coefficients (e.g., determine a pre-defined list of combinations of {information of SD-FD pair (number of total pairs, or number of pairs per port, or density of each pair), number of FD bases per port M, ratio for max number of non-zero coefficients}, receive a combination from the list, or determine a pre-defined list of combinations of {number of CSI-RS ports P, number of FD bases per port M, ratio for max number of non-zero coefficients beta}, receive a combination from the list). The max number of non-zero coefficients can be derived from the ratio, number of CSI-RS ports, number of SD-FD pairs, number of FD bases, e.g., K0=P*M*beta or K0=P′*M*beta. In some cases, K0 is the max number of non-zero coefficients per layer and 2K0 is the max number of total non-zero coefficients across all layers. In some cases, the UE may receive configuration of exact FD bases (FD bases indices) and the number of FD bases should be subject to the reported capability or dependent on the number of CSI-RS ports or number of SD-FD pairs.

In some cases, a UE may report capability information regarding support of partial band CSI reporting. In some cases, the UE may report an explicit capability of number of partial bands B, or reporting a capability of whether supporting >1 partial band. In some cases, a UE may jointly report the partial band capability with at least one of number of CSI-RS ports P, and information of SD-FD pair or number of FD bases per port M. For example, the UE may report a number of CSI-RS ports P plus partial band information, information of SD-FD pair plus partial band information, or a Number of FD bases plus partial band information, or a number of CSI-RS ports P/information of SD-FD pair plus number of FD bases plus partial band information.

In such cases, the UE may receiving configuration of partial band information comprises number of partial bands or partial band size via a ratio vs. the subband size. In some cases, the UE may receive a joint configuration of partial band information with at least one of number of CSI-RS ports P, information of SD-FD pair or number of FD bases per port M (e.g., determine a pre-defined list of combinations of {number of CSI-RS ports P and/or information of SD-FD pair (number of total pairs, or number of pairs per port, or density of each pair) and/or number of FD bases per port M, information regarding partial band}, receive a combination from the list). For a CSI report with B partial bands, the number of CSI-RS ports or SD-FD pairs and the CSI-RS resources may be counted B times in active resource and port counting.

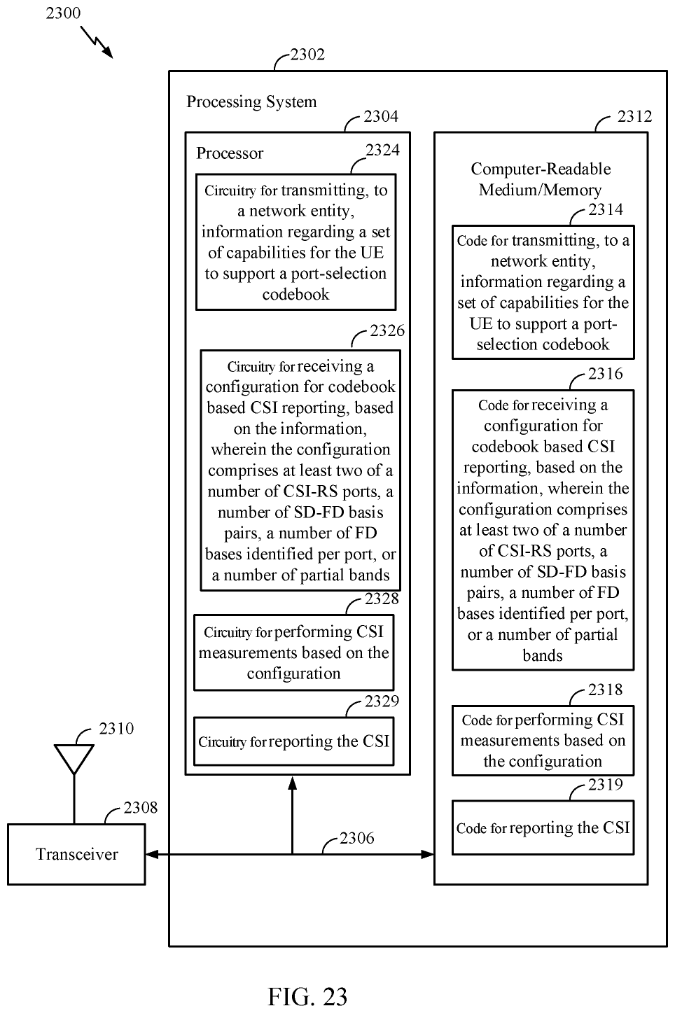

FIG. 23 illustrates a communications device 2300 that may include various components (e.g., corresponding to means-plus-function components) configured to perform operations for the techniques disclosed herein. For example, the device 2300 may be a UE configured to perform operations illustrated in FIG. 15. The communications device 2300 includes a processing system 2302 coupled to a transceiver 2308 (e.g., a transmitter and/or a receiver). The transceiver 2308 is configured to transmit and receive signals for the communications device 2300 via an antenna 2310, such as the various signals as described herein. The processing system 2302 may be configured to perform processing functions for the communications device 2300, including processing signals received and/or to be transmitted by the communications device 2300.

The processing system 2302 includes a processor 2304 coupled to a computer-readable medium/memory 2312 via a bus 2306. In certain aspects, the computer-readable medium/memory 2312 is configured to store instructions (e.g., computer-executable code) that when executed by the processor 2304, cause the processor 2304 to perform the operations illustrated in FIG. 15, or other operations for performing the various techniques discussed herein. In certain aspects, computer-readable medium/memory 2312 stores code 2314 for transmitting, to a network entity, information regarding a set of at least two capabilities for the UE to support a port-selection codebook; code 2316 for receiving a configuration for codebook based CSI reporting, based on the information, wherein the configuration comprises at least two of a number of CSI-RS ports, a number of SD-FD basis pairs, a number of FD bases identified per port, or a number of partial bands; code 2318 for performing CSI measurements based on the configuration; and code 2319 for reporting the CSI. In certain aspects, the processor 2304 has circuitry configured to implement the code stored in the computer-readable medium/memory 2312. The processor 2304 includes circuitry 2324 for transmitting, to a network entity, information regarding a set of at least two capabilities for the UE to support a port-selection codebook; circuitry 2326 for receiving a configuration for codebook based CSI reporting, based on the information, wherein the configuration comprises at least two of a number of CSI-RS ports, a number of SD-FD basis pairs, a number of FD bases identified per port, or a number of partial bands; circuitry 2328 for performing CSI measurements based on the configuration; and circuitry 2329 for reporting the CSI.

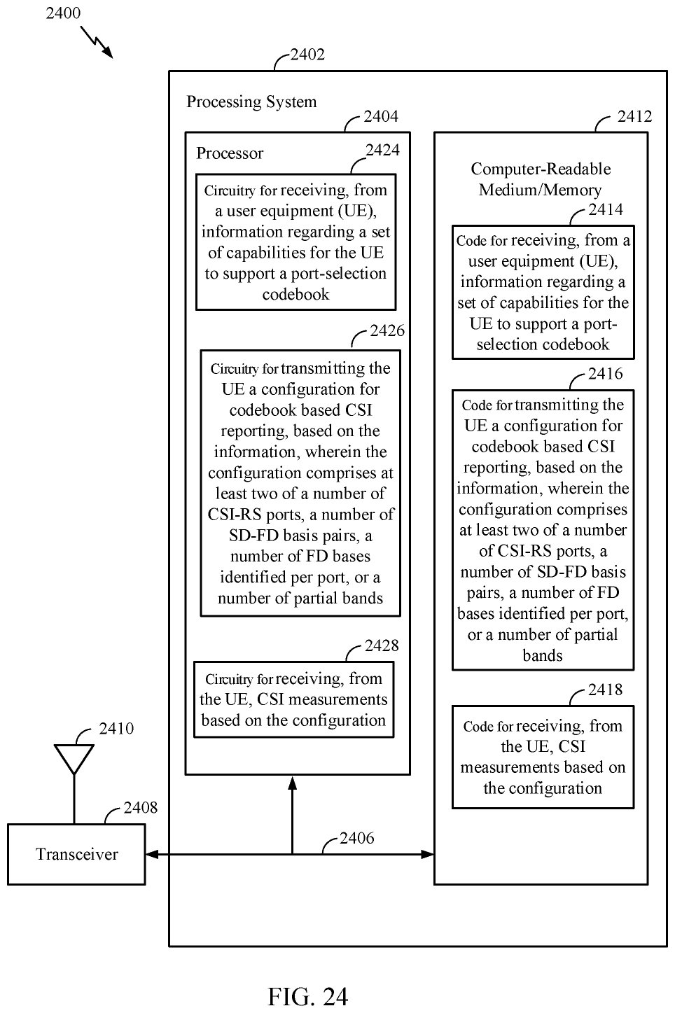

FIG. 24 illustrates a communications device 2400 that may include various components (e.g., corresponding to means-plus-function components) configured to perform operations for the techniques disclosed herein. For example, the device 2400 may be a UE configured to perform operations illustrated in FIG. 15. The communications device 2400 includes a processing system 2402 coupled to a transceiver 2408 (e.g., a transmitter and/or a receiver). The transceiver 2408 is configured to transmit and receive signals for the communications device 2400 via an antenna 2410, such as the various signals as described herein. The processing system 2402 may be configured to perform processing functions for the communications device 2400, including processing signals received and/or to be transmitted by the communications device 2400.

The processing system 2402 includes a processor 2404 coupled to a computer-readable medium/memory 2412 via a bus 2406. In certain aspects, the computer-readable medium/memory 2412 is configured to store instructions (e.g., computer-executable code) that when executed by the processor 2404, cause the processor 2404 to perform the operations illustrated in FIG. 15, or other operations for performing the various techniques discussed herein. In certain aspects, computer-readable medium/memory 2412 stores code 2414 for receiving, from a user equipment (UE), information regarding a set of at least two capabilities for the UE to support a port-selection codebook; code 2416 for transmitting the UE a configuration for codebook based CSI reporting, based on the information, wherein the configuration comprises at least two of a number of CSI-RS ports, a number of SD-FD basis pairs, a number of FD bases identified per port, or a number of partial bands; and code 2418 for receiving, from the UE, CSI measurements based on the configuration. In certain aspects, the processor 2404 has circuitry configured to implement the code stored in the computer-readable medium/memory 2412. The processor 2404 includes circuitry 2424 for receiving, from a user equipment (UE), information regarding a set of at least two capabilities for the UE to support a port-selection codebook; circuitry 2426 for transmitting the UE a configuration for codebook based CSI reporting, based on the information, wherein the configuration comprises at least two of a number of CSI-RS ports, a number of SD-FD basis pairs, a number of FD bases identified per port, or a number of partial bands; and circuitry 2428 for receiving, from the UE, CSI measurements based on the configuration.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. For example, the various processor shown in FIG. 3 may be configured to perform operations of FIGS. 12, 13, 15, 16, 19 and/or 20).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein (e.g., instructions for performing the operations described herein and illustrated in FIGS. 12, 13, 15, 16, 19 and/or 20).

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communications by a user equipment (UE), comprising:
transmitting, to a network entity, information regarding capability for the UE to support a port-selection codebook, wherein the capability comprises at least two of a number of channel state information reference signal (CSI-RS) ports, a number of spatial domain and frequency domain (SD-FD) basis pairs, information regarding frequency domain (FD) bases, or a number of partial bands;
receiving a configuration for codebook based channel state information (CSI) reporting, based on the information, wherein the configuration comprises at least two of a number of CSI-RS ports, a number of SD-FD basis pairs, information regarding FD bases, or a number of partial bands;
performing CSI measurements based on the configuration; and
reporting the CSI.

2. The method of claim 1, wherein the information regarding FD bases comprises a number of FD bases identified per CSI-RS port.

3. The method of claim 1, wherein:
the CSI comprises a set of linear combination coefficients for each transmission layer and each partial band; and
each linear combination coefficient is associated with a combination of a CSI-RS port or SD-FD basis pair and a FD basis.

4. The method of claim 1, wherein the information regarding capability for the UE to support the port-selection codebook comprises information regarding UE capability to support SD-FD basis pairs.

5. The method of claim 4, wherein the information regarding the UE capability to support SD-FD basis pairs comprises:
a number of SD-FD basis pairs per resource;
a number of resources; and
a total number of SD-FD basis pairs across all resources.

6. The method of claim 4, wherein the information regarding the UE capability to support SD-FD basis pairs comprises:
for each of one or more different numbers of CSI-RS ports supported by the UE, a maximum number of SD-FD basis pairs mapped to that number of CSI-RS ports.

7. (canceled)

8. The method of claim 6, wherein the configuration for codebook based CSI reporting indicates an actual total number of SD-FD basis pairs mapped to a number of CSI-RS ports for CSI-RS reporting.

9. (canceled)

10. The method of claim 4, wherein the information regarding the UE capability to support SD-FD basis pairs comprises:
for a number of CSI-RS ports supported by the UE, a maximum number of SD-FD basis pairs mapped to each of the CSI-RS ports.

11. (canceled)

12. The method of claim 4, wherein the configuration for codebook based CSI reporting indicates an actual total number of SD-FD basis pairs mapped to each of the CSI-RS ports.

13. (canceled)

14. The method of claim 4, wherein the information regarding the UE capability to support SD-FD basis pairs comprises:
for a number of CSI-RS ports supported by the UE, a lowest density of SD-FD basis pairs supported by the UE.

15. (canceled)

16. The method of claim 14, wherein the configuration for codebook based CSI reporting indicates an actual SD-FD basis pair density for a configured number of CSI-RS ports.

17. The method of claim 16, wherein the actual SD-FD basis pair density is jointly configured with the number of CSI-RS ports.

18. The method of claim 1, wherein the information regarding capability for the UE to support the port-selection codebook explicitly indicates whether the UE supports more than one FD basis per CSI-RS port or more than one FD basis per SD-FD pair.

19. The method of claim 18, wherein the information regarding capability for the UE to support the port-selection codebook explicitly indicates a number of FD bases per CSI-RS port or a number of FD bases per SD-FD pair supported by the UE.

20. The method of claim 18, wherein the information regarding capability for the UE to support the port-selection codebook comprises a joint indication of at least one of:
the number CSI-RS ports and a number of FD bases per CSI-RS port;
information regarding SD-FD basis pairs and a number of FD bases per SD-FD basis pair; or
the number of CSI-RS ports, the information regarding SD-FD basis pairs, and the number of FD bases per CSI-RS port.

21. The method of claim 20, wherein the configuration for codebook based CSI reporting comprises a joint indication of at least one of:
a configured number CSI-RS ports and a configured number of FD bases per CSI-RS port;
information regarding configured SD-FD basis pairs and a configured number of FD bases per SD-FD basis pair; or
a configured number of CSI-RS ports, the information regarding SD-FD basis pairs, and the configured number of FD bases per CSI-RS port.

22. The method of claim 18, wherein the information regarding capability for the UE to support the port-selection codebook comprises a joint indication of:
a number of CSI-RS ports per SD-FD basis pair, a number of FD bases per CSI-RS port, and a maximum number of non-zero coefficients for the UE to report.

23. The method of claim 22, wherein the configuration for codebook based CSI reporting comprises a joint indication of:
a configured number of CSI-RS ports per SD-FD basis pair, a configured number of FD bases per CSI-RS port, and a configured maximum number of non-zero coefficients for the UE to report.

24. The method of claim 1, wherein the information regarding capability for the UE to support the port-selection codebook indicates whether the UE supports CSI-RS reporting on more than one partial band.

25. (canceled)

26. The method of claim 24, wherein the configuration for codebook based CSI reporting indicates at least one of a number of partial bands or a partial band size.

27-29. (canceled)

30. A method for wireless communications by a network entity, comprising:
receiving, from a user equipment (UE), information regarding a set of at least two capabilities for the UE to support a port-selection codebook;
transmitting the UE a configuration for codebook based channel state information (CSI) reporting, based on the information, wherein the configuration comprises at least two of a number of CSI reference signal (CSI-RS) ports, a number of spatial domain and frequency domain (SD-FD) basis pairs, information regarding frequency domain (FD) bases, or a number of partial bands; and
receiving, from the UE, CSI based on the configuration.

31. The method of claim 30, wherein the information regarding the FD bases comprises a number of FD bases identified per CSI-RS port.

32. The method of claim 30, wherein:
the CSI comprises a set of linear combination coefficients for each transmission layer and each partial band; and
each linear combination coefficient is associated with a combination of a CSI-RS port or SD-FD basis pair and a FD basis.

33. The method of claim 30, wherein the information regarding the set of the at least two capabilities for the UE to support the port-selection codebook comprises information regarding UE capability to support SD-FD basis pairs.

34-46. (canceled)

47. The method of claim 30, wherein the information regarding the set of the at least two capabilities for the UE to support the port-selection codebook explicitly indicates whether the UE supports more than one FD basis per CSI-RS port or more than one FD basis per SD-FD pair.

48. The method of claim 47, wherein the information regarding the set of the at least two capabilities for the UE to support the port-selection codebook explicitly indicates a number of FD bases per CSI-RS port or a number of FD bases per SD-FD pair supported by the UE.

49. The method of claim 47, wherein the information regarding the set of the at least two capabilities for the UE to support the port-selection codebook comprises a joint indication of at least one of:
a number CSI-RS ports and number of FD bases per CSI-RS port;
information regarding SD-FD basis pairs and a number of FD bases per SD-FD basis pair; or
the number of CSI-RS ports, the information regarding SD-FD basis pairs, and the number of FD bases per CSI-RS port.

50. (canceled)

51. The method of claim 47, wherein the information regarding the set of the at least two capabilities for the UE to support the port-selection codebook comprises a joint indication of:
a number of CSI-RS ports per SD-FD basis pair, a number of FD bases per CSI-RS port, and a maximum number of non-zero coefficients for the UE to report.

52-60. (canceled)

61. An apparatus for wireless communications by a user equipment (UE), comprising:
a memory comprising computer executable instructions;
at least one processor configured to execute the computer executable instructions and cause the UE to:
transmit, to a network entity, information regarding capability for the UE to support a port-selection codebook, wherein the capability comprises at least two of a number of channel state information reference signal (CSI-RS) ports, a number of spatial domain and frequency domain (SD-FD) basis pairs, information regarding frequency domain (FD) bases, or a number of partial bands;
receive a configuration for codebook based channel state information (CSI) reporting, based on the information, wherein the configuration comprises at least two of a number of CSI-RS ports, a number of SD-FD basis pairs, information regarding FD bases, or a number of partial bands;
perform CSI measurements based on the configuration; and
report the CSI.

62. An apparatus for wireless communications by a network entity, comprising:
a memory comprising computer executable instructions;
at least one processor configured to execute the computer executable instructions and cause the network entity to:
receive, from a user equipment (UE), information regarding a set of at least two capabilities for the UE to support a port-selection codebook;
transmit the UE a configuration for codebook based channel state information (CSI) reporting, based on the information, wherein the configuration comprises at least two of a number of CSI reference signal (CSI-RS) ports, a number of spatial domain and frequency domain (SD-FD) basis pairs, information regarding frequency domain (FD) bases, or a number of partial bands; and
receive, from the UE, CSI measurements based on the configuration.
